(19) United States
(12) Patent Application Publication
(10) Pub. No.: US 2020/0196592 A1
(43) Pub. Date: Jun. 25, 2020

(54) HUNTING BLIND

(71) Applicant: BUSHNELL HOLDINGS, INC., Overland Park, KS (US)

(72) Inventors: Herbert J. Harris, Brandon, MS (US); Michael E. Powell, Madison, MS (US); Christopher M. Seaton, Tampa, FL (US); Timothy R. Seaton, Tampa, FL (US)

(73) Assignee: BUSHNELL HOLDINGS, INC., Overland Park, KS (US)

(21) Appl. No.: 16/229,161

(22) Filed: Dec. 21, 2018

(51) Int. Cl. A01M 31/02; E04H 15/00; E04H 15/48

(52) U.S. Cl. CPC A01M 31/025; E04H 15/48; E04H 15/001

(57) ABSTRACT

A lightweight, portable, and collapsible outdoor shelter having independently collapsible walls and roof supporting a one-way transmissive flexible cover. The outdoor shelter provides a hunter or observer an improved field-of-view while providing effective camouflage and shelter from the elements and the surrounding environment. Aspects of the exemplary shelter provide easy transport, set-up, breakdown, and storage.

### FIELD OF TECHNOLOGY

The present disclosure relates generally to an outdoor shelter, and more particularly to a portable and collapsible hunting blind for use by hunters and outdoorsmen.

### BACKGROUND

Portable outdoor structures, such as hunting blinds and shelters, allow hunters, photographers, bird watchers, and other outdoor enthusiasts to observe and interact with wildlife without revealing their presence. Shelters or blinds are often used to mask the presence of the hunter or observer by providing a camouflaged structure that blends in with the surrounding environment. The portability of such structures allows the observer to set up and position a blind at the site of observation without having to set up a permanent structure.

Traditional hunting blinds and outdoor shelters are often limited in the number of windows and cutouts through which a hunter or observer can monitor their surroundings from the interior of the shelter. Fabrics and other materials used to camouflage the shelter are traditionally opaque, leaving only the windows and cutouts as vantage points to observe the environment outside the shelter. Such configurations hamper observers with a limited field-of-view and, as such, observers may be more likely to miss a potential encounter with the wildlife. Further, in a hunting environment, these limitations create safety risks due to the restriction of a hunter's peripheral field-of-view and associated awareness of his surroundings while armed. Conversely, the more prevalent the windows and cutouts are in a traditional shelter, the more the observer sacrifices in terms of obscurity and invisibility to the wildlife.

Additionally, traditional hunting blinds and shelters can be cumbersome, heavy, and difficult to set-up, break-down, and relocate. Shelters and blinds capable of holding multiple occupants are heavy and difficult to pack and carry. Smaller blinds and shelters may be lighter, however they sacrifice the number of observers the shelter can accommodate and feature far fewer viewing angles and windows.

### SUMMARY

The present disclosure generally provides for a lightweight, portable, and collapsible outdoor shelter having independently collapsible walls and roof supporting a one-way transmissive flexible cover. The outdoor shelter provides a hunter or observer an improved field-of-view while providing effective camouflage and shelter from the elements and the surrounding environment. Aspects of the exemplary blinds provide easy transport, set-up, breakdown, and storage.

According to one aspect of the disclosure, a collapsible structure is provided. The collapsible structure may include a flexible cover defining at least one wall and a roof. The at least one wall may include at least a one-way transmissive mesh portion and one fixture point. At least one wall support may be collapsibly engaged with at least one wall of the flexible cover. The at least one wall support may include a hub having a center point and defining at least one aperture. The hub may further include at least one substantially rigid frame member having a distal end and a proximal end. The proximal end may be retained in the at least one aperture while the distal end may be engaged with the at least one fixture point of the flexible cover. The substantially rigid frame member may have a length greater than a distance from the hub center point to the fixture point. The at least one substantially rigid frame member may be configured to pivot between an engaged position and a collapsed position with the at least one hub. The engaged position may form a tension in the at least one wall about the at least one wall support.

According to another aspect of the present disclosure, a collapsible shelter may include a flexible cover defining four walls and a roof. Each wall may include four fixture points and the flexible cover may include a first portion and a second portion. The first portion may include a one-way transmissive material and the second portion may include an opaque, light-absorbing material. Four independently collapsible wall supports may each be engaged with each wall of the flexible cover. Each wall support may include a hub having a center point and defining four apertures and four substantially rigid frame members. Each substantially rigid frame member may have a distal end and a proximal end. Each proximal end may be retained in each aperture. The distal end may be engaged with the at least one fixture point of the flexible cover. Each substantially rigid frame member may have a length greater than a distance from the hub center point to the fixture point. The at least one substantially rigid frame member may be configured to pivot between an engaged position and a collapsed position with the at least one hub. The engaged position may form a tension in the at least one wall about the at least one wall support. A roof hub and four roof support members may engage the roof of the flexible cover.

According to another aspect of the disclosure, a method of erecting a structure is disclosed. According to the exemplary method, a plurality of substantially rigid frame members of a first of a plurality of independent wall supports may be spread from a collapsed position. Each of the plurality of substantially rigid frame members may have a distal end and a proximal end. The proximal end may be engaged in an aperture of a hub while the distal end may be engaged with at least one fixture point of a flexible cover. Each of the substantially rigid frame members may have a length greater than a distance from the hub center point to the fixture point.

Further according to the exemplary method, a pressing force may be applied on the hub of the first independent wall support against the flexible cover, maintaining the hubs of a remainder of the plurality of independent wall supports in proximity to each other. The plurality of substantially rigid frame members may engage the hub to form a first concave wall in the flexible cover. A subsequent pressing force may be applied to each of the hubs of the remainder of the plurality of independent wall supports such that the respective substantially rigid frame members of each independent wall support engage each hub to form a plurality additional concave walls. A pressing force may be applied to a roof hub to engage a plurality of roof support members into an expanded position.

### BRIEF DESCRIPTION OF THE DRAWINGS

Embodiments of devices, systems, and methods are illustrated in the figures of the accompanying drawings which are meant to be exemplary and non-limiting, in which like references are intended to refer to like or corresponding parts, and in which:

FIG. 1 depicts a perspective view of a portable shelter according to an embodiment of the disclosure.

FIG. 2a depicts a top-down view of a wall support according to an embodiment of the disclosure.

FIG. 2b depicts a perspective view of a hub of a wall support according to an embodiment of the disclosure.

FIG. 2c depicts a perspective view of a hub according to an embodiment of the disclosure.

FIG. 2d depicts a perspective view of a hub body according to an embodiment of the disclosure.

FIG. 2e depicts a perspective view of an uncapped hub according to an embodiment of the disclosure.

FIG. 2f depicts an elevation view of a hub and engaged frame members of a wall support according to an embodiment of the disclosure.

FIG. 2g depicts a cut-away view of the hub and engaged frame members of the wall support according to an embodiment of the disclosure.

FIG. 2h depicts a perspective view of a hub cap according to an embodiment of the disclosure.

FIG. 2i depicts a perspective view of the hub, with the hub cap removed, and frame members in a partially engaged orientation according to an embodiment of the disclosure.

FIG. 2j depicts a perspective view of the hub and frame members in a collapsed orientation according to an embodiment of the disclosure.

FIG. 3a depicts a frame member according to an embodiment of the disclosure.

FIG. 3b depicts a proximal end of a frame member according to an embodiment of the disclosure.

FIG. 4a depicts a perspective view of a portable outdoor shelter in a collapsed orientation according to an embodiment of the disclosure.

FIG. 4b depicts a perspective view of a portable outdoor shelter in a partially-collapsed orientation according to an embodiment of the disclosure.

FIG. 4c depicts a perspective view of a portable outdoor shelter with a first expanded wall support according to an embodiment of the disclosure.

FIG. 5a depicts a perspective view of a portable outdoor shelter according to an embodiment of the disclosure.

FIG. 5b depicts an opposing perspective view of the portable outdoor shelter of FIG. 5a according to an embodiment of the disclosure.

FIG. 5c depicts a partial-panoramic internal view of the portable outdoor shelter of FIG. 5a.

FIG. 5d depicts a partial-panoramic internal view of the portable outdoor shelter of FIG. 5a with a removable backdrop.

FIG. 6a depicts a perspective view of a portable outdoor shelter according to an embodiment of the disclosure.

FIG. 6b depicts an opposing perspective view of the portable outdoor shelter of FIG. 6a.

FIG. 6c depicts a partial-panoramic internal view of the portable outdoor shelter of FIG. 6a.

FIG. 7 depicts a method of erecting a shelter according to an aspect of the present disclosure.

### DETAILED DESCRIPTION

The present disclosure generally relates to lightweight, portable, and collapsible shelters and structures, such as a hunting blind. A portable outdoor shelter may include an internal frame of at least one wall support, a flexible cover, a door, and at least one window or cutout. While the embodiments of the portable outdoor shelter and its features may be described as a “blind” or a “hunting blind” used by a hunter, it is appreciated that the scope of the disclosure is not limited solely to hunting. Use of the various embodiments and their features are applicable to, and contemplated for, other indoor or outdoor activities including, without limitation, birdwatching, animal/nature observation, camping, outdoor recreation or the like.

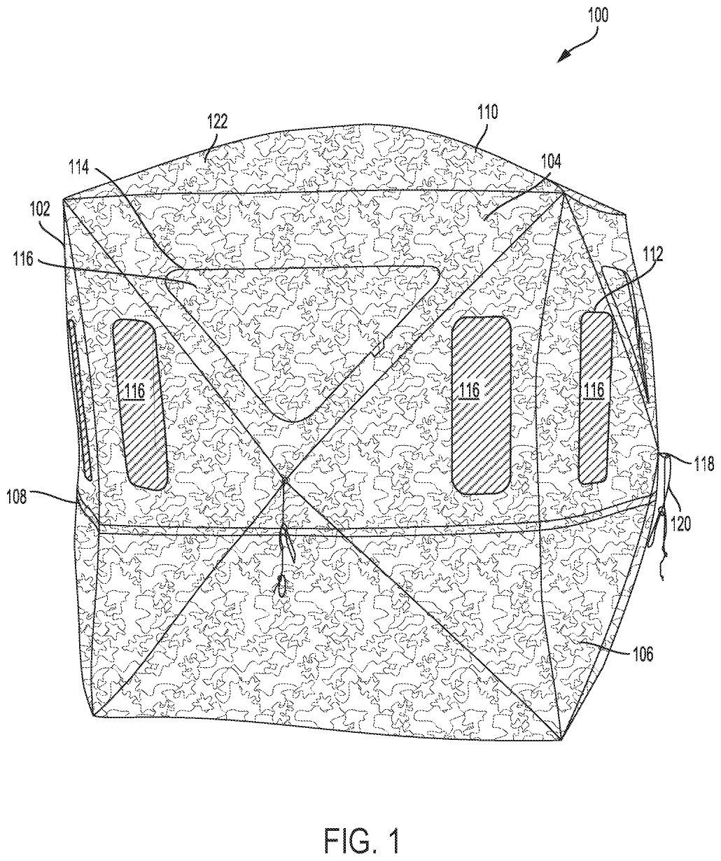

Referring to FIG. 1, an illustrative embodiment of a portable outdoor shelter 100, or blind, is shown. The shelter 100 may include a flexible cover 102 disposed over, or affixed to, an internal frame (not shown) to form an enclosure. The internal frame may include one or more wall supports that expand and collapse independently of each other. The flexible cover 102 may include a camouflage pattern 122 depicted on all or a portion of an exterior side. The flexible cover 102 may be divided into sections or side walls each having an upper portion 104 and a lower portion 106. The upper portion 104 may include a one-way transmissive mesh material, adapted to allow a hunter or observer occupying the shelter 100 to monitor and observe their surroundings without being seen from the outside. The one-way transmissivity of the mesh material may allow an occupant on the inside of the shelter 100 to see out, however a person or animal on the outside of the shelter may not see through the material from the outside into the shelter. The lower portion 106 of the flexible cover 102 may be a non-transmissive material that does not allow light to pass through. Where the two portions meet, a joining strap 108 may be added to the exterior of the flexible cover 102 to hide the resulting seam. The seam may be formed by the joining of the respective materials of the upper portion 104 and the lower portion 106 using any number of known methods, including without limitation, stitching, sewing, gluing, molding, or the like. Additionally, the joining strap 108 may be adapted to define holes or gaps to hold foliage and other items for use as camouflage, further disguising the shelter 100.

A roof panel 110 may be formed from opaque material of the flexible cover 102. The flexible cover 102 may include one or more windows 114 allowing an unobstructed view from the shelter 100. Additional side windows 112 may also be provided. A window cover 116 may be used to cover the window when not in use to prevent visibility into the shelter 100. A fastener 118, such as a bolt, eye-hook, or the like, may be used to secure the flexible cover 102 in place against the internal frame. The fastener 118 may also be fitted with a strap 120 for applying force on the internal frame. The strap 120 may also serve as a tie-down, guywire, or other mechanism for use in securing the shelter 100 to the ground or another structure.

A one-way transmissive mesh material, such as described in U.S. patent application Ser. No. 15/444,909 (Seaton) which is incorporated herein by reference in its entirety, may form the upper portion 104 of the flexible cover 102. The mesh may include an exterior side and an interior side. The exterior side may be camouflaged or have a camouflage pattern 122 printed thereon. The mesh may be adapted to allow an occupant within the enclosure to see outwardly through the mesh to view their surroundings. The interior side of the mesh material may include a light absorbing coating, e.g., flat black color or other dark color, to diminish any light reflection and improve the occupant's ability to see through the mesh to view their surroundings. The camouflage exterior portion may be adapted to draw attention to the camouflage pattern 122 and away from the apertures of the mesh. The camouflage exterior, in conjunction with the light absorbing flat black color interior side of the mesh material, may give the impression that the mesh material is opaque when viewed from the exterior of the shelter 100, thereby obscuring the presence of the occupants inside the enclosure. The camouflage pattern 122 may include multiple colors blended to create a camouflage effect as well as other graphical elements to distinguish the camouflage pattern 122. Additionally, the window covers 116 may be formed of the opaque material or the one-way transmissive material. The exterior facing side of the window cover 116 may include the camouflage pattern 122.

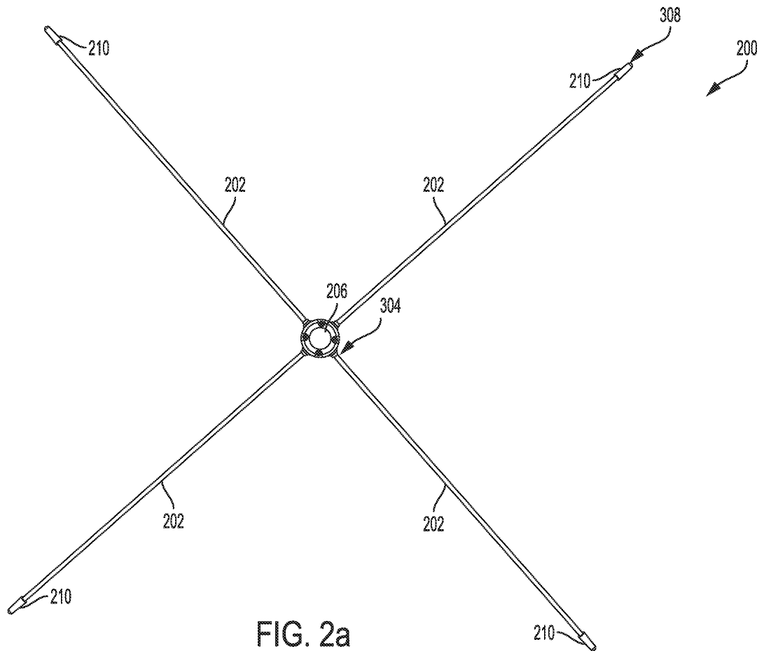

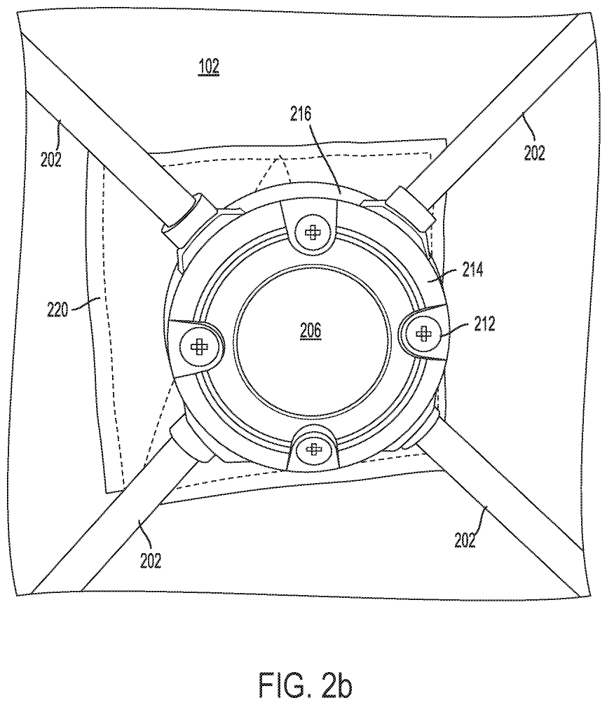

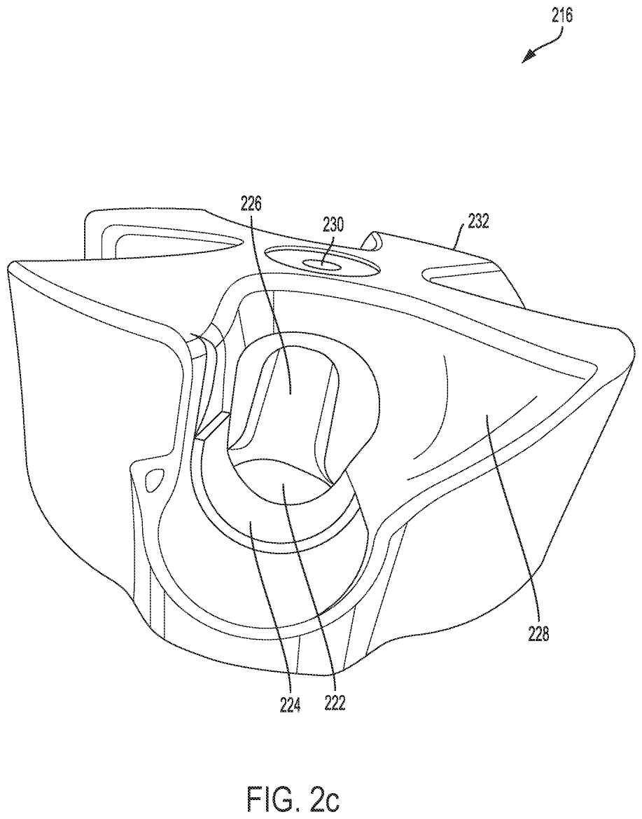

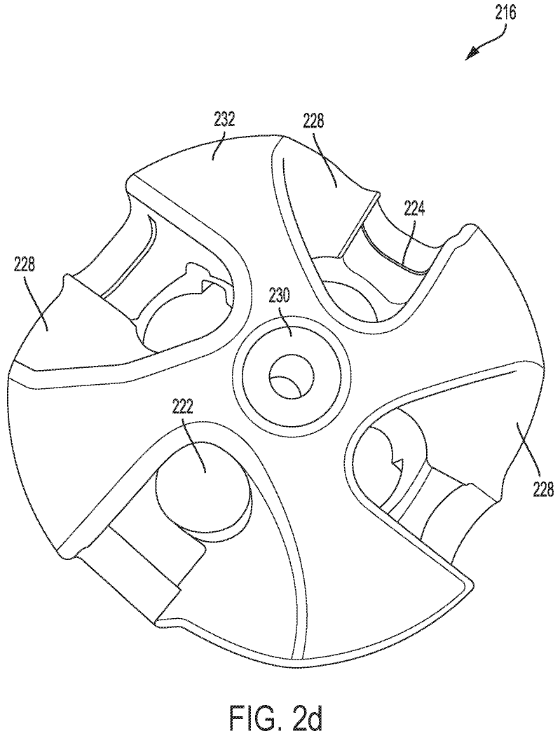

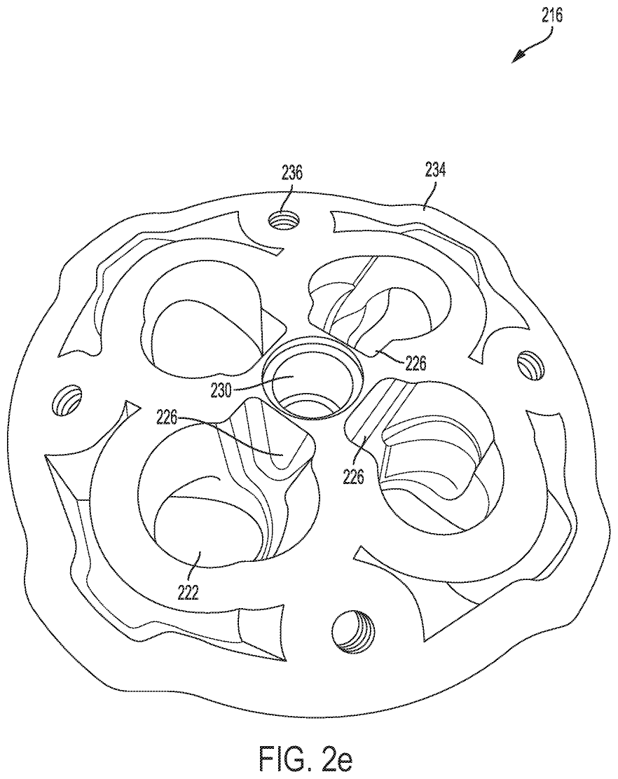

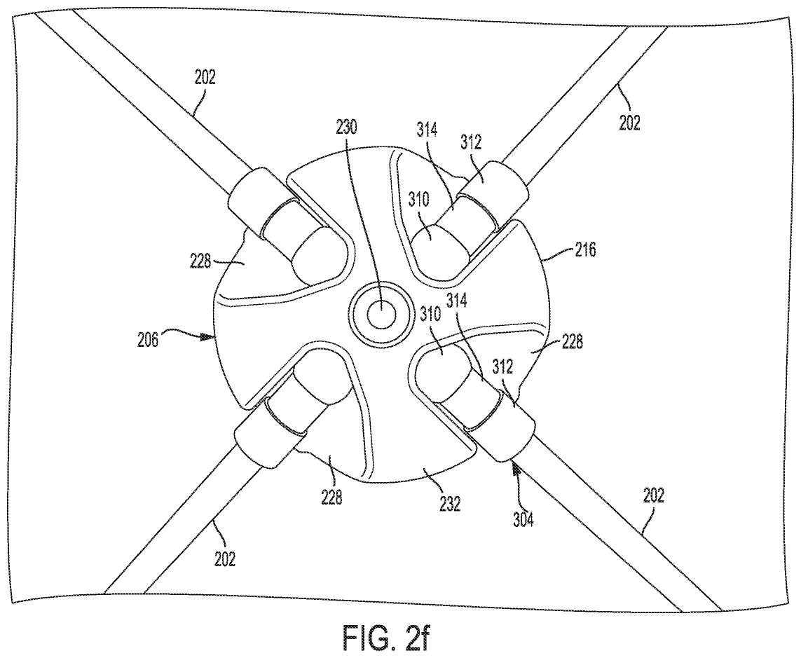

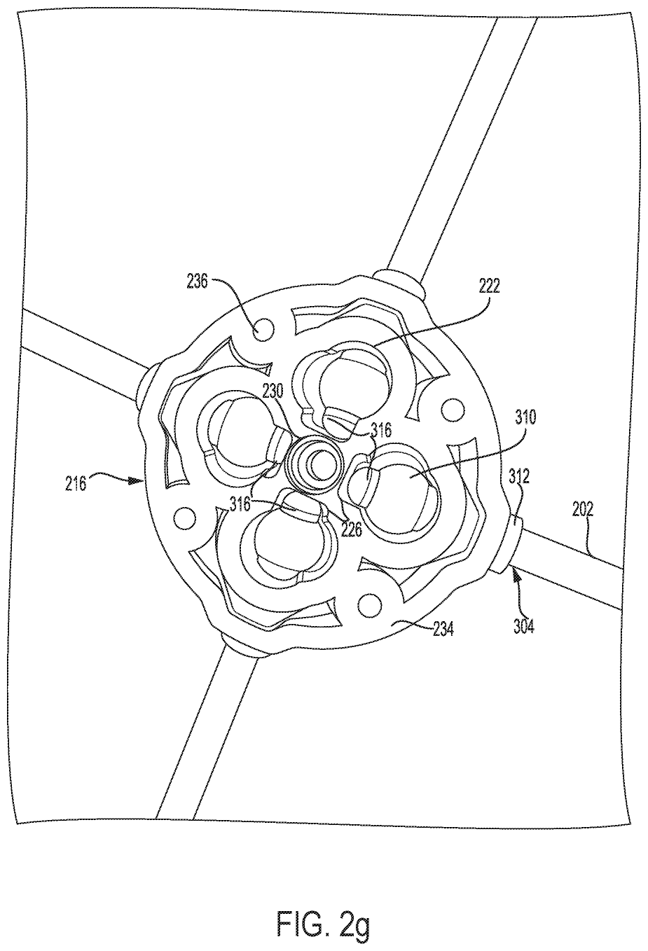

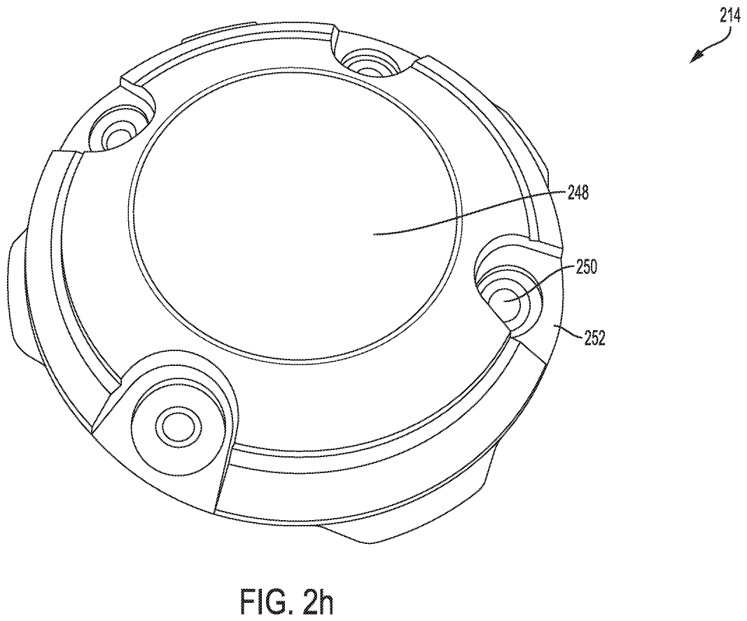

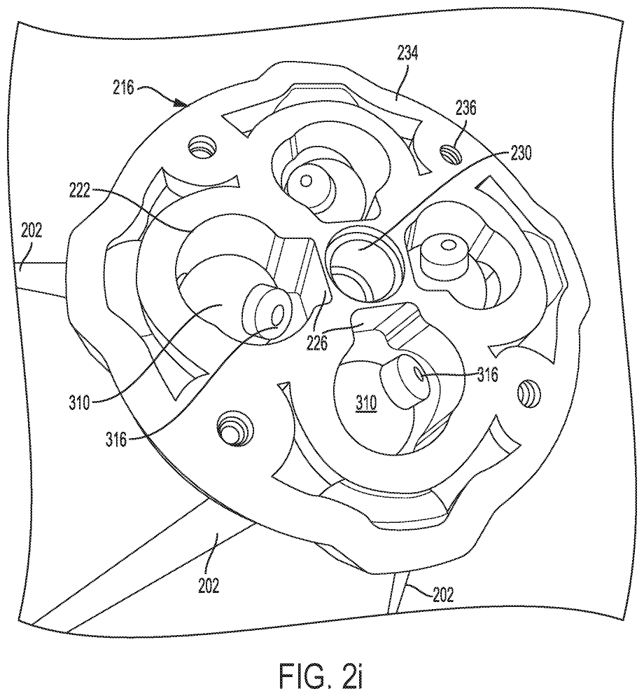

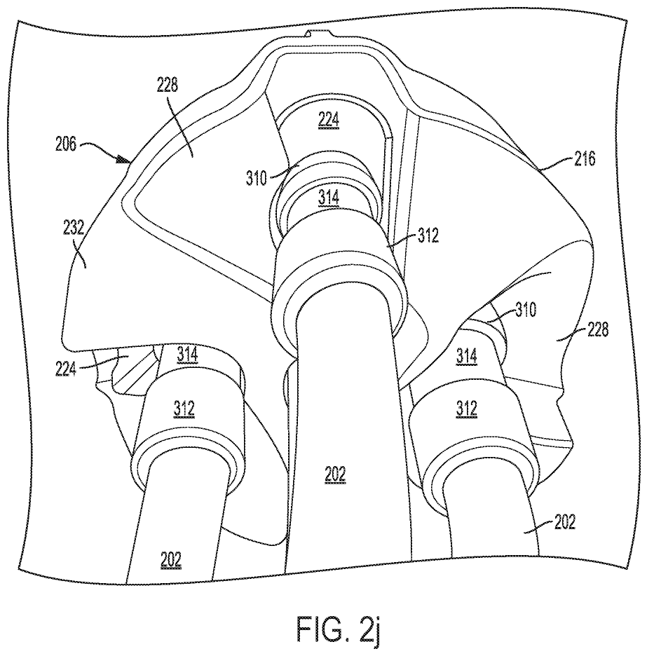

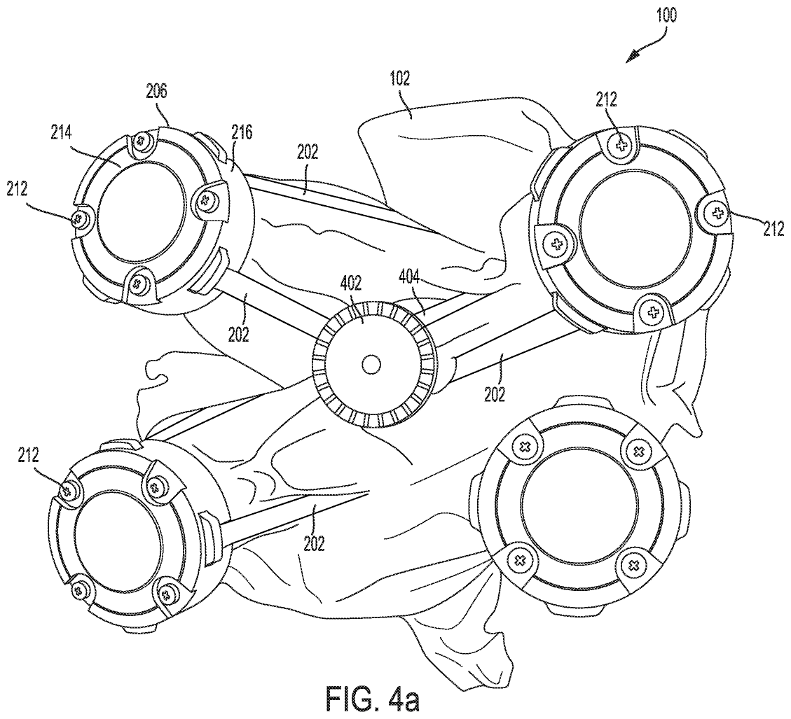

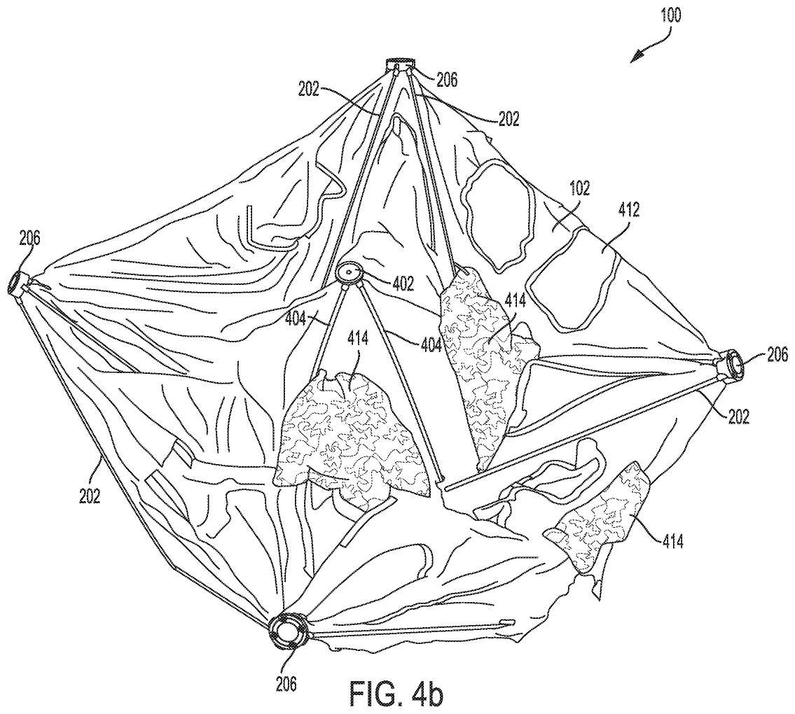

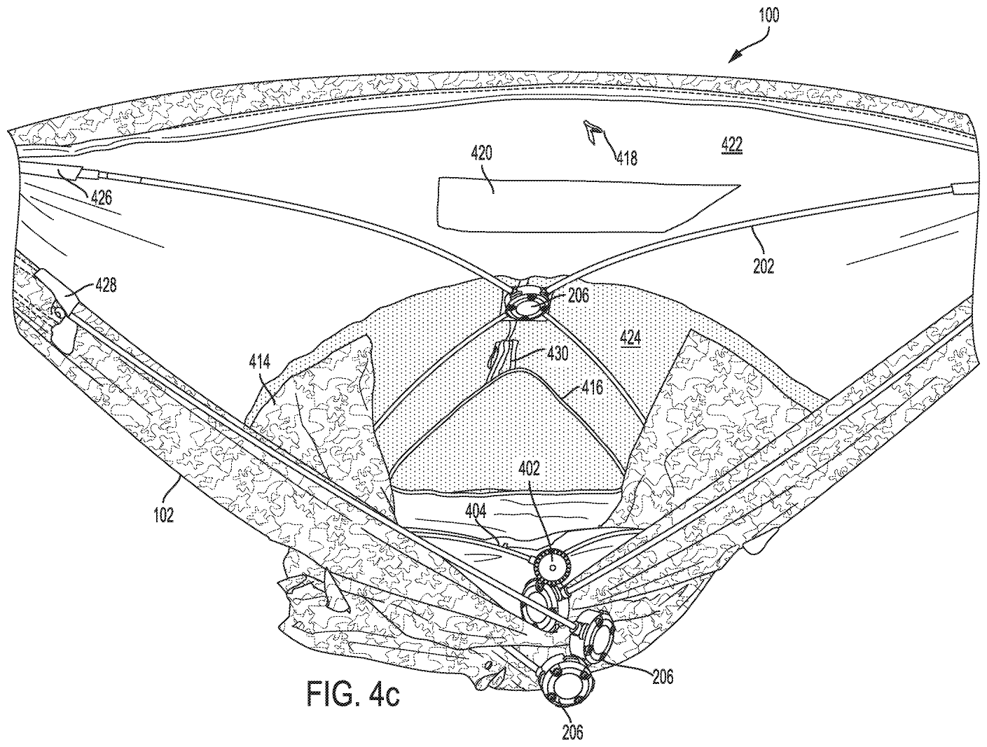

FIG. 2a illustrates an embodiment of a wall support 200 of the shelter 100. The wall support 200 may be independently collapsible and expandable from any other wall supports included in the shelter, as detailed below. The illustrative embodiment may include four wall supports 200, although it should be appreciated that in other embodiments fewer or more wall supports 200 may be implemented. The frame of the shelter 100 may include at least one of the wall supports 200 using a tensioned pop-up design configured to support and expand the flexible cover 102 while also allowing the shelter 100 to be collapsed into an easily stored shape and size. The wall supports 200 may be characterized by at least one frame member 202 engaging with a hub 206. The frame members may be substantially rigid and made from a polymeric material, or the like. The substantial rigidity of the frame members may allow the frame members to bend or flex on an arc when a force is applied upon the proximal and distal ends or on a portion therebetween without breaking, snapping or splintering. The frame may be set up by applying force to the hub 206 thereby orienting the frame members 202 against the flexible cover 102 and forcing the flexible cover 102 to expand. The frame may be collapsed by applying an opposite force to the hub causing the wall support 200 to re-orient the frame members 202 until they are aligned substantially parallel to other frame members 202 engaging the hub 206 and substantially perpendicular to the hub 206 itself (as illustrated in FIGS. 2j and 4a).

According to the embodiment of FIG. 2a each wall support 200 may include four frame members 202. The frame members 202, described in detail below, may include a proximal end 304 that engages with the hub 206 and a distal end 308 that engages with, or is received by, the flexible cover 102 of the shelter 100.

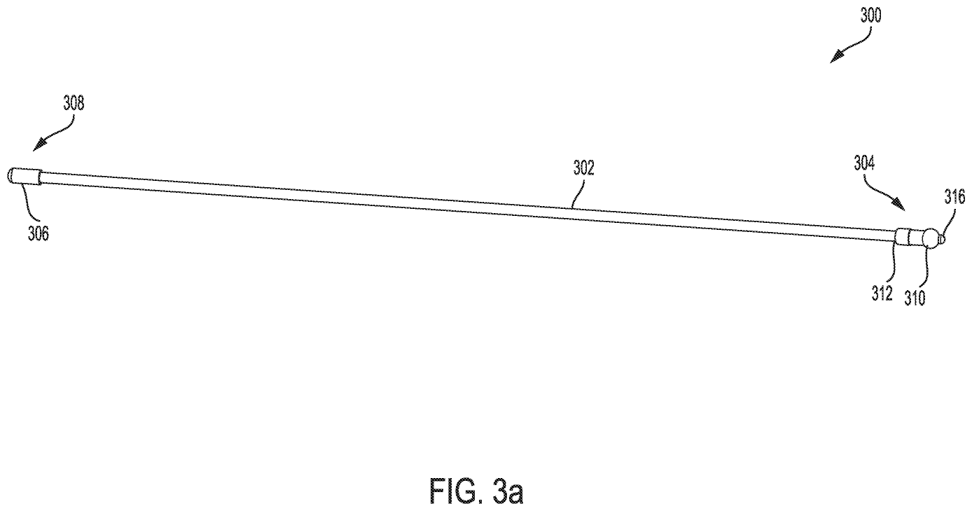

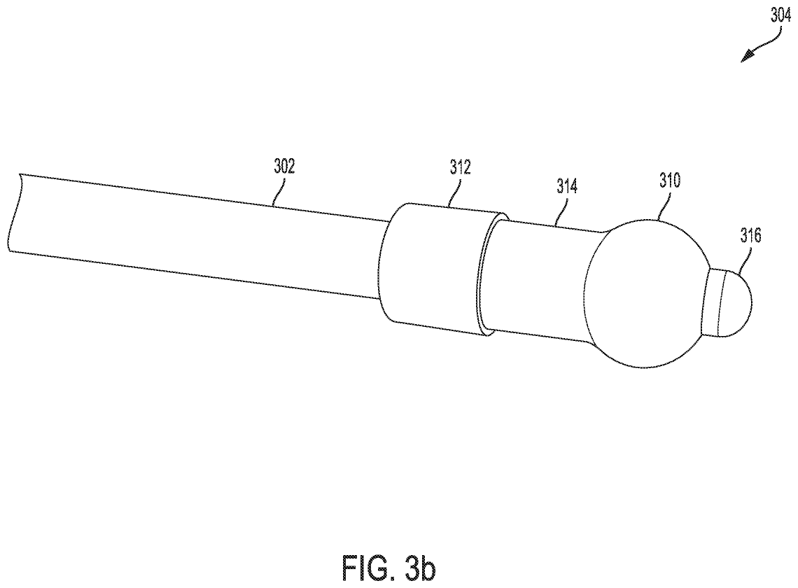

Each frame member 202, illustrated in greater detail in FIG. 3a, may include a strut 302 having a proximal end 304 and a distal end 38. The frame member 202 may include a strut cap 306 disposed at the distal end 308. The strut cap 306 may be adapted to engage with a fastener or a recess of the flexible cover 102. The frame member 202 may be formed of a single pole formed of a plastic, metal, fiberglass, or other suitable material. The frame member 202 may be adapted to be flexible allowing the frame member 202 to bend slightly when in an expanded orientation. The proximal end 304 of the frame member 300 may include a strut head 310, strut collar 312 and a protrusion 316. FIG. 3b illustrates an enlarged view of an embodiment of the proximal end 304. The strut head 310 may include a protrusion 316 mounted on the strut head 310. The strut head 310 may engage with the strut 302 through a strut collar 312. The strut collar 312 may be connected to the strut head 310 by a strut neck 314.

As further described below, the frame members 202 engage the hub 206 and the flexible cover 102 in such a manner as to establish an outward tension across the walled section of the flexible cover 102 and forming a convex-shaped wall of the shelter 100. When the four wall supports 200 and a roof support, described below, are expanded, the shelter enclosure is formed. The shelter frame may be collapsed by applying an opposite force inward on the hubs 206 of each wall support 200 causing the frame members 202 to partially disengage from the hub 206 until the frame members 202 are aligned substantially parallel to each other and substantially perpendicular to the hub 206 (again, as illustrated in FIGS. 2j and 4a).

FIG. 2b illustrates an enlarged view of a hub 206 of a wall support 200. The hub 206 may include a body 216 and a hub cap 214. The body 216 and the hub cap 214 of the hub 206 may be secured to each other by one or more fasteners 212. The hub 206 may be affixed to the flexible cover 102 through a reinforcing patch 220 or other material. As described herein, the hub 206 may be affixed to the flexible cover 102 using a threaded bolt, eye hook, screw or other known fastener that passes from the exterior of the blind through the flexible cover 102 and is secured to the hub 206.

FIGS. 2c-2e illustrate views of the body 216 of the hub 206. FIG. 2c depicts a perspective view of a first side 232 of the body 216. FIG. 2d depicts a top-view of the first side 232 of the body 216. FIG. 2e depicts an opposing or second side 234 of the body 216. The body 216 of the hub 206 may be a molded plastic or polymeric body or may be formed from another substantially rigid and sturdy material. The body 216 may define one or more hub apertures 222, each sized and shaped, or otherwise adapted, to receive the proximal end 304 of the frame members 202 so that the frame member is connected but rotatable in the hub aperture 222.

As illustrated in FIGS. 2c-2d, the hub aperture 222 may include a hub depression 224 for receiving and engaging the strut collar 312 of the frame member 202 when the wall support 200 is in an engaged configuration. Additionally, a hub notch 226 may be defined in the hub aperture 222 for receiving and engaging the protrusion 316 on the strut head 310 of the frame member 202. The hub notch 226 may be sized and shaped to form a friction fit about the protrusion 316 of the strut head 310, maintaining the frame member 202 in a secure position.

A sloped depression 228 may be defined in or adjacent to the hub depression 224. The sloped depression 228 may be adapted to allow the frame member 202 and strut 302 maneuverability when a force acts upon the wall support 200 during collapsing and expanding operations. The sloped depression 228 may be adapted to receive and guide the frame member 202 from a stored orientation into the hub depression 224 as the wall support 200 is expanded. As the wall support 200 is expanded and engaged, the frame member 202, and thus the protrusion 316, may be guided into the hub depression 224 and the hub notch 226, respectively, to hold the frame member 202 in an engaged orientation (i.e. extended as illustrated in FIG. 2a).

FIG. 2e illustrates a perspective view of the second side 234 of the body 216 of the hub 206. A fastener aperture 230 may be included in the body 216 to receive a fastener to affix the hub 206 to the flexible cover 102. The second side 234 may be adapted to engage or receive the hub cap 214. A fastener may be included to fasten the hub cap 214 to the second side 234 of the body 216 using threaded receiving apertures 236 disposed on the second side 234 of the body 216 of the hub 206.

FIGS. 2f-2g depict the body 216 of the hub 206 engaged with the frame members 202 of a wall support 200. FIG. 2f illustrates an elevated view of the first side 232 of the body 216, while FIG. 2g depicts an opposing view of the second side 234 of the body 216, with the hub cap 214 removed for illustrative purposes. The wall supports 200 may be expanded by applying a force to the hub 206 thereby orienting the frame members 202, which are engaged with the flexible cover 102, against the flexible cover 102 and forcing the flexible cover 102 to expand. The frame member 202 may be engaged in an expanded orientation with the hub 206 using a frictional force or a fastener, such as a tie-down or the like, to hold the frame members 202 in a desired orientation. The frame member 202 may engage the hub 206 in an expanded orientation whereby the strut head 310 disposed on the proximal end 304 of the frame member 202 engages the hub aperture 222, the protrusion 316 engages the hub notch 226, and the strut collar 312 engages the hub depression 224 (as seen in FIG. 2g).

FIG. 2h illustrates a perspective view of the hub cap 214 covering the hub 206. The hub cap 214 may include an outer surface 248 configured to cover the hub body 216, thereby retaining the strut head 310 within the hub aperture 222 and preventing the frame member 202 from sliding or falling out of the hub 206. The hub cap 214 may include or define one or more receiving apertures 250 and support collars 252, through which a fastener may engage the hub cap 214 of the hub 206. The outer surface 248 of the hub cap 214 may be sized and shaped to accommodate the pressing force applied to the hub 206 when engaging or collapsing the wall supports 200. For example, the outer surface 248 may be adapted to receive the palm of a hand pressing against the hub cap 214 of the hub 206 to engage the frame members 202 of the wall support 200. The fitting engagement between the frame members 202, the hub 206 and the flexible cover 102 provide for the tension applied to the flexible cover 102 to form the shape and size of the shelter enclosure. The outer surface 248 may similarly be sized and shaped to receive a hand grip to receive a pulling force to collapse the wall support 200 from the shape and size of the shelter enclosure causing the wall support 200 to orient the frame members 202 substantially parallel to each other and substantially perpendicular to the hub 206 itself.

FIG. 2i illustrates a perspective view of the second side 234 of the hub body 216 with the frame members 202 rotated into a partially-collapsed orientation. The hub body 216 is shown without the hub cap 214 for illustrative purposes. As shown, the strut heads 310 and protrusions 316 are not fully engaged in the hub apertures 222 and hub notches 226, and therefore may rotate freely through the hub apertures 222. As the wall support 200 collapses, the protrusions 316 disengage with the hub notches 226 and rotate away as the frame members 202 and rotate towards a substantially perpendicular alignment with the hub 206 itself.

FIG. 2j illustrates the wall support 200 in a substantially fully collapsed orientation with the frame members 202 disposed substantially parallel to each other and substantially perpendicular extending from the hub 206. The strut heads 310 may be retained by the hub apertures 222 due to the circumference of the strut head 310 exceeding the size of the opening defined by the hub aperture 222. The wall supports 200 have been depicted above without the flexible cover 102 for purposes of illustration.

FIG. 4a illustrates a portable outdoor shelter 100 in a collapsed orientation. The flexible cover 102 may be operatively connected to a frame. The frame may include four wall supports 200, each including a hub 206 and frame members 202 as previously described, and a collapsible roof support with a roof hub 402 and roof support members 404. According to one embodiment, the roof hub 402 may be smaller than the hubs 206 of the wall supports 200 yet operate in a similar manner. The smaller roof hub 402 may be used for the roof panel 110 to provide additional flexibility and ease with which the shelter 100 may be expanded and collapsed. The roof hub 402, when fully engaged with the roof support members 404 may form a tensioned pressure against a roof panel 110, in a similar manner as the wall supports 200. The wall supports 200 and the roof supports may expand and collapse independently of each other.

The hub 206 and frame members 202 may be attached to the flexible cover 102 such that, upon collapsing, the flexible cover 102 may likewise collapse or fold in between and around the frame members 202. The hubs 206 and roof hub 402 cooperatively, yet independently, collapse to lay the wall support frame members 202 and roof support members 404 substantially parallel with each other such that wall hubs 206 and roof hub 402 align facing the same direction. Upon collapsing the wall supports 200 and the roof support, the flexible cover 102 may be configured and attached to the wall support frame members 202 and roof support members 404 such that the lower portion 106 of the flexible cover 102 fold over the upper portion 104 of the flexible cover 102, including those portions having a one-way transmissive mesh.

FIG. 4b illustrates a perspective view of an embodiment of the portable outdoor shelter 100 in a semi-expanded orientation. As the wall hubs 206 and roof hub 402 are pushed away from each other, the flexible cover 102 may unfold or expand, revealing the lower portion 106 of the flexible cover 102 and one or more window apertures 412 and one or more window covers 414. Each wall hub 206 and the roof hub 402 may be selectively pressed to engage the frame members 202 and roof support members 404, respectively into an expanded position. As the wall frame members 202 are engaging with the wall hub 206, the flexible cover 102 may likewise expand such that the upper portion 104 of the flexible cover 102 unfold about the hub 206. As the wall frame members 202 engage, the hub 206 may provide a directed force against the flexible cover 102 causing the flexible cover 102 to expand and become taut against the wall frame members 202 (as seen in FIG. 1). The roof hub 402 and roof support members 404 may operate in a similar manner.

FIG. 4c illustrates a side view of an embodiment of the portable outdoor shelter 100 with one expanded wall support 200 and accompanying expanded wall of the flexible cover 102. According to one embodiment, an expansion operation may include selectively engaging a first hub 206 with its respective frame members 202, while maintaining the remaining wall hubs 206 and the roof hub 402 in close proximity to each other. Doing so may allow the upper portion 424 of the wall of the flexible cover 102 to unfold over the hub 206 and frame members 202 to form an expanded wall support 200. The frame members 202 may be sized to have a length greater than half of the diagonal length of a side of the flexible cover 102. The frame members 202 may be flexibly forced to bow or bend when in a fully engaged orientation. A fastener strap 430 may be disposed on the hub 206 for applying a force to the hub 206 when setting up the shelter 100. The fastener strap 430 may also be used as a tie down for securing the shelter 100 to the ground or other structure. To engage the frame members 202 with the hub 206, an outward force may be applied to the hub 206 causing the frame members 202 to slightly flex and push the flexible cover 102 outwardly, engaging in the hub 206, as previously described. The wall section, when engaged, may form and maintain a convex shape, as the flexible cover 102 is pulled taut against the frame. Each remaining wall support 200 may then be subsequently expanded followed by the roof support, thus forming the enclosed structure.

The flexible cover 102 may be connected to the frame using strut recesses 426 disposed on the interior of the flexible cover 102. A cover strap 428 may be used to adjust tension in the flexible cover 102. According to the orientation of the portable shelter 100 in FIG. 4c, the wall portion as expanded may be upside-down. That is, the upper portion 424 of the wall, may be closest to the ground during expansion/assembly. The lower portion 422 of the wall may be higher. As the walls and roof are expanded, the shelter 100 may be rotated to place the shelter 100 right-side-up.

The upper portion 424 may be formed from, or include, a one-way transmissive mesh material, as described in the U.S. patent application Ser. No. 15/444,909 referenced herein. The upper portion 424 may also include or define a window 416 and include window covers 414 that may be secured to the flexible cover in either open or closed positions. The window covers 414 may be formed of an opaque material or a one-way transmissive mesh material.

The lower portion 422 of the wall may be formed from or include an opaque material to prevent the transmission of light through the flexible cover 102. Additionally, a pouch 420 may be included for storing tools and accessories on the interior side of the lower portion 422 of the flexible cover 102. A fastener (not shown), such as a stake, may be used for securing the shelter 400 to a location. The shelter 100 may be configured with a receiver 418 to engage the fastener, thereby affixing the portable outdoor shelter 100 in place.

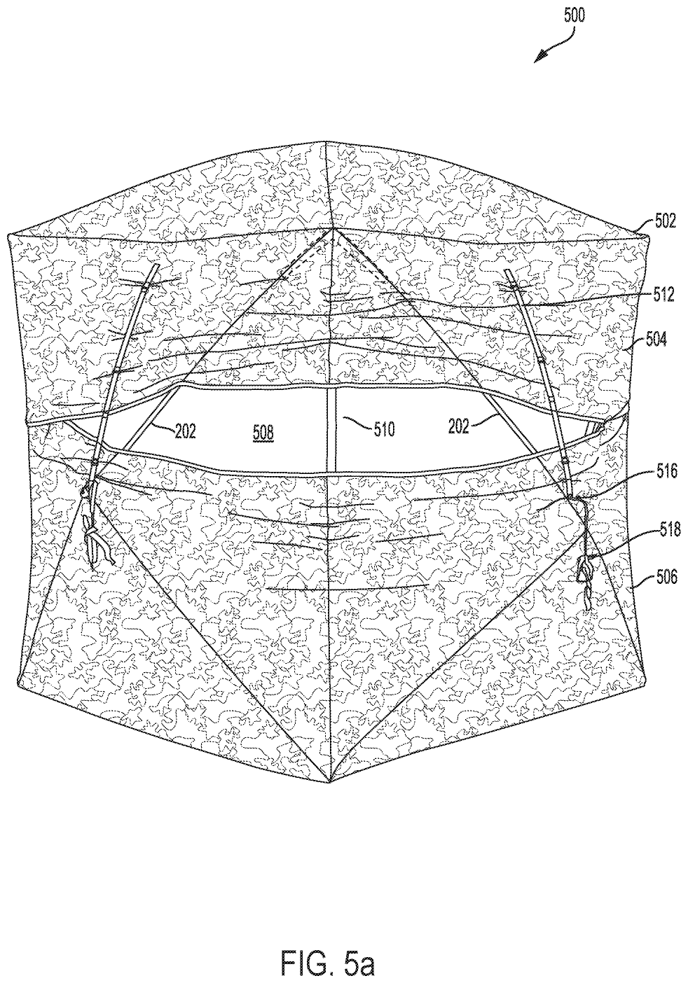

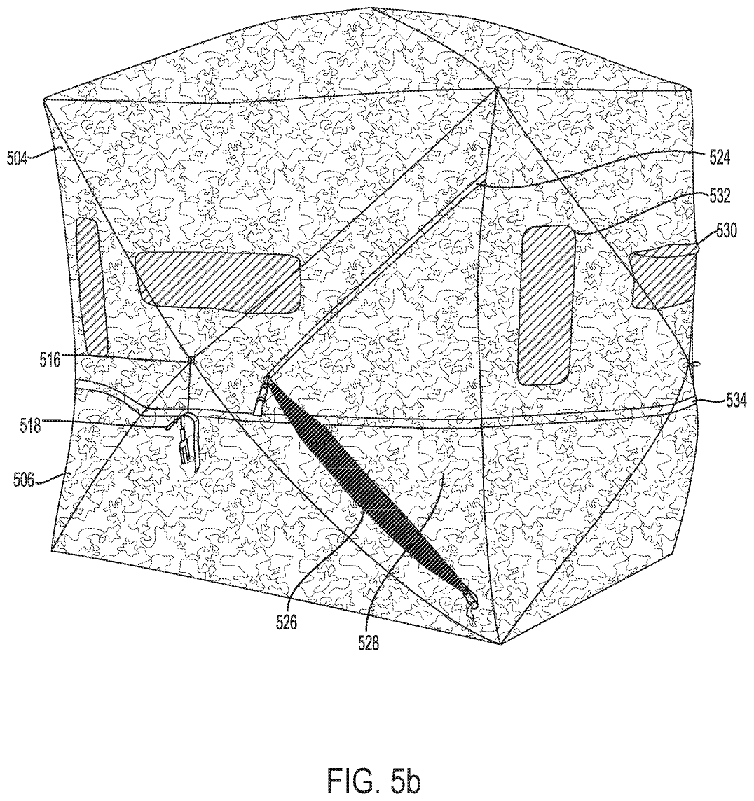

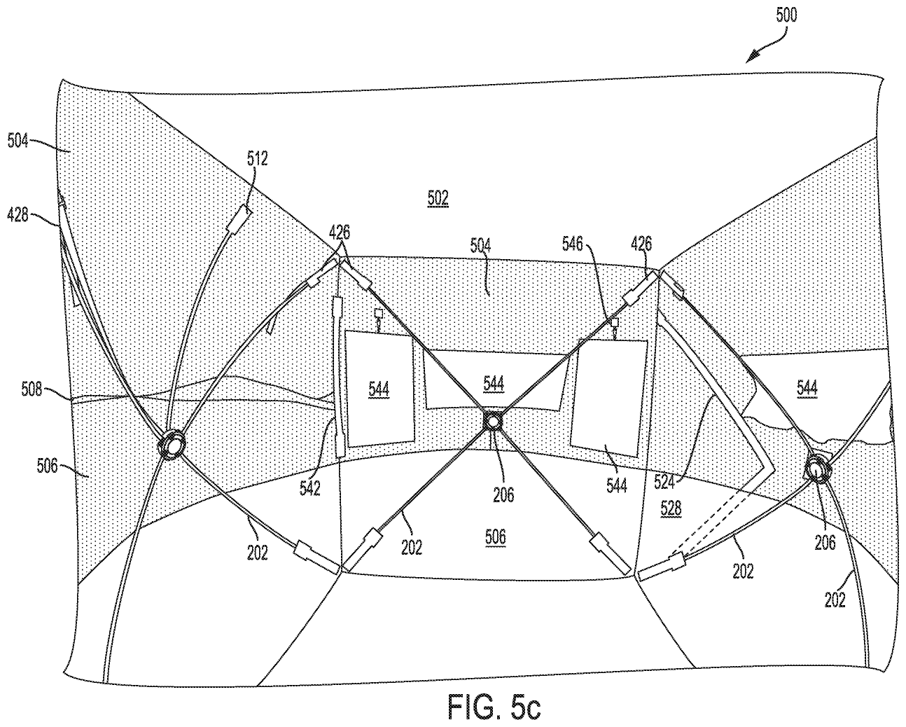

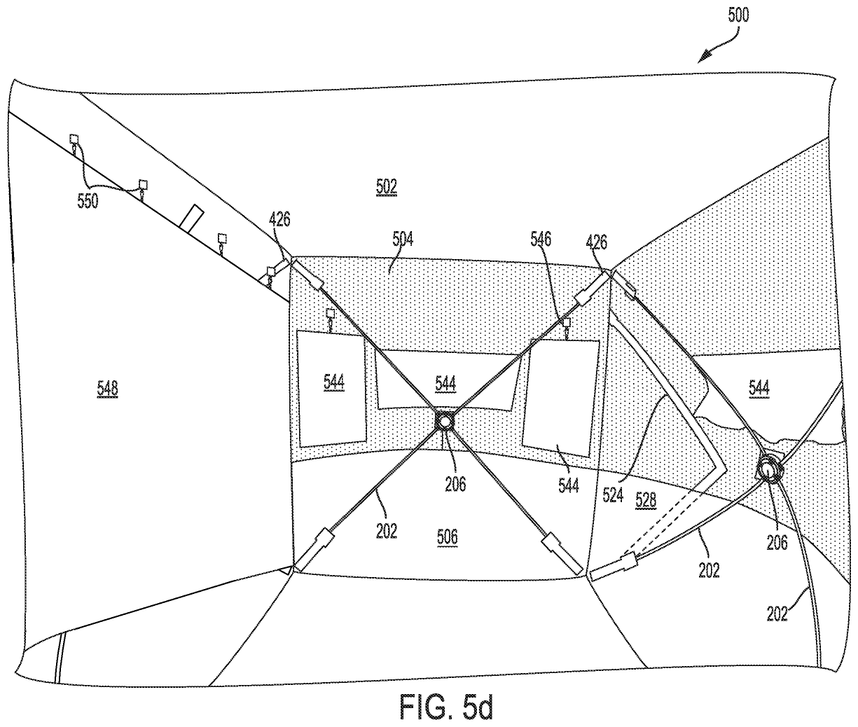

FIGS. 5a-d depict an embodiment of the disclosure in which a portable outdoor shelter 500 with potentially 360° view of the exterior surroundings is provided. FIG. 5a illustrates a corner view of the portable outdoor shelter 500, where two of four side walls meet. Each side wall of the portable outdoor shelter 500 at a top portion meets a flexible cover 502. The flexible cover 502 may have a camouflaged or other design as viewed from the exterior.

As described herein, each side wall may include an upper portion 504 that, from the interior of the shelter 500, provides a one-way transmissivity allowing the occupants inside of the shelter 500 to see out, but not allow sight into the enclosure. The transmissive upper portion may be illustratively approximately 60% of the total height of a side wall, with the lower, non-transmissive, portion being approximately 40% of the height of the side wall, in order to limit light transmissivity and help obscure the view from the outside into the shelter. The lower and upper portions may be of different ratios of non-transmissive material to transmissive material, and may function for the intended purpose in a range of approximately 20%-50% lower portion non-transmissive material to 80%-50% upper portion transmissive material. In one embodiment, with a side wall of approximately 55-61 inches, the ratio is 24 inches of lower portion non-transmissive material to approximately 32-37 inches of upper portion transmissive material.

Referring still to FIGS. 5a-d, the flexible cover 502 may be configured to form or define a corner window 508 along a split between the upper portion 504 and a lower portion 506 of the flexible cover 502, which constitutes approximately one-third of the side wall. The lower portion 506 of the flexible cover 502 may be formed from or include an opaque, i.e., non-transmissive, material. The corner window 508 may be opened along a slide track 510. The corner window 508 may be operated by grasping the upper portion 504 and the lower portion 506 and pulling the respective portions of the flexible cover 502 away from each other along the slide track 510 to open the corner window 508, or towards each other to close the corner window 508. The upper portion 504 and the lower portion 506 may overlap with each other when the corner window 508 is fully closed.

The corner window 508 may be appropriately sized and shaped to allow an occupant of the shelter 500 a wide angle of view or aim. For example, a hunter occupying the shelter 500 may take advantage of the width of the corner window 508 if aiming at a moving target. Rather than having the hunter's aim restricted by a small window or other opening, the hunter's aim can traverse the corner window 508 across its width tracking the target as it moves.

The frame of the portable outdoor shelter 500 on which the flexible cover 502 rests may include four wall supports each including a hub and four frame members 202, as described in detail hereinbefore, which may flex against the flexible cover 502 causing the flexible cover 502 to expand over the frame when the portable outdoor shelter 500 is in a set-up orientation. Exterior straps 512 may be disposed on an exterior of the flexible cover 502 to allow the placement of foliage or other camouflaging equipment for further disguising the portable outdoor shelter 500. The hub of the frame, as described above, may be disposed against the flexible cover 502 using a fastener 516 which may be furnished with a fastener strap 518 for applying a force to the hub during set up.

FIG. 5b illustrates an alternate view of the portable outdoor shelter 500. A door 528 may be formed on the flexible cover 502 for providing an entry way into the enclosure of the portable outdoor shelter 500. The door 528 may be operated using a fastener 524. The door 528 may provide or define an opening 526 that can be partially opened and closed to allow ingress to or egress from the shelter 500 depending on the size of the entryway needed. A joining strap 534 may be disposed across the intersection or seam of the lower portion 506 and the upper portion 504 of the flexible cover 502. The joining strap 534 may define one or more loops or holes to allow the placement of foliage or other camouflaging equipment for further disguising the portable outdoor shelter 500. The upper portion 504 of the flexible cover 502 may include one or more windows 530, 532.

FIG. 5c illustrates an internal view of an embodiment of the portable outdoor shelter 500 in the expanded orientation. The shelter 500 may be formed by a frame including four wall supports 200 (only three shown in this FIG. 5c), each including a hub 206 and a plurality of frame members 202. A roof hub and roof frame members, as described hereinbefore (not shown in this FIG. 5c), may support the roof of the flexible cover 502. The frame may be operatively connected to the flexible cover 502 by one or more strut recesses 426 disposed on an interior of the flexible cover 502. The strut recesses 426 may be disposed at or near the corners of the flexible cover 502. The strut recesses 426 may be sized and shaped to receive the strut and strut cap of the frame members 202 with a friction fit to maintain the positioning of the frame members 202. The cover strap 428 may be used to adjust tension in the flexible cover 502 to improve the fit of the flexible cover 502 on the frame. The flexible cover 502 may include or define one or more windows 530, 532 in the upper portion 504 of the flexible cover 502. Window covers 544 may be fastened to a window fastener 546 for covering the windows 530, 532. The window covers 544 may be sewn or otherwise affixed to the interior surface of the flexible cover 502 on one or more sides, such as a bottom side. In operation, the window covers 544 may be detached from the window fastener 546, allowing the window covers 544 to fall yet remain attached along the affixed side. The quick-release and attachment configuration of the window covers 544 provides additional advantages to the occupants of the shelter 500, allowing the occupants to quickly open and close the windows without disturbing the target of the occupants' attention. The door 528 may be opened from within the enclosure of the portable outdoor shelter 500 using a fastener 524, in one embodiment the fastener 524 may be a zipper. Additionally, one or more second fasteners 542, such as a zipper, may be used to open or close the corner window 508.

The upper portion 504 of the side wall of the flexible cover 502 may include or form a one-way transmissive mesh material, dimensioned proportionally as described hereinbefore. The one-way transmissive mesh material may provide a line-of-sight from the inside of the shelter 500, while appearing opaque when viewed from the outside. According to the embodiment shown in FIG. 5c, the upper portion 504 may provide a 360° view from the inside of the shelter 500. The lower portion 506 of the flexible cover 502, and the roof may include or form an opaque material that may absorb or reduce the reflection of light from the interior of the shelter 500.

FIG. 5d depicts a partial-panoramic internal view of the portable outdoor shelter 500 of FIG. 5a with a removable/movable backdrop blackout panel 548. The removable backdrop 548 may be fastened to a side of the shelter 500 using at least one fastener 550, or a plurality (as shown in FIG. 5d), disposed on an interior side wall of the shelter 500. The removable backdrop 548 may be configured to be moved and fastened to any wall of the enclosure to reduce the transmissivity of light through the 360° transmissive upper portion 504 of the wall. The backdrop 548, which is implemented as a flat black colored panel, may also provide a light absorbing surface to absorb reflecting light and further obscure the occupants inside the shelter 500 from outside view.

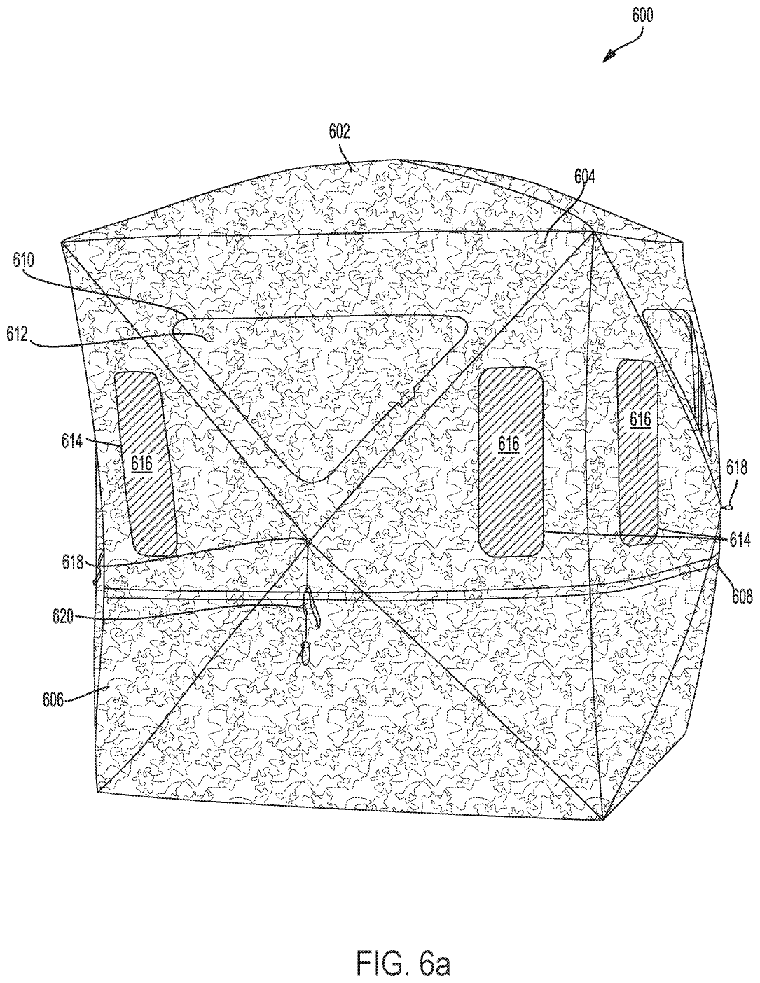

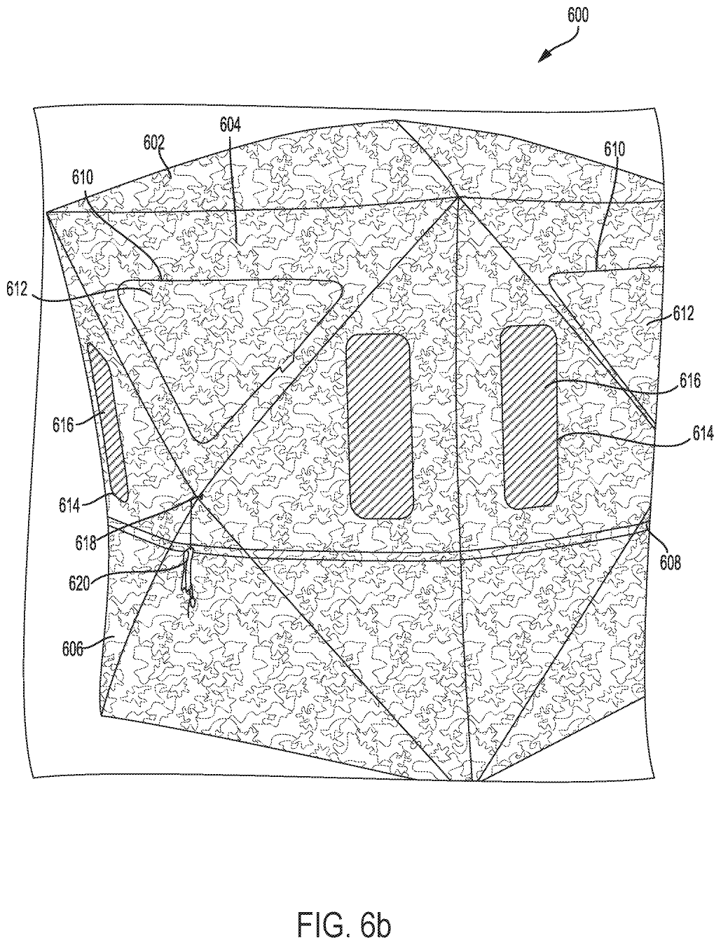

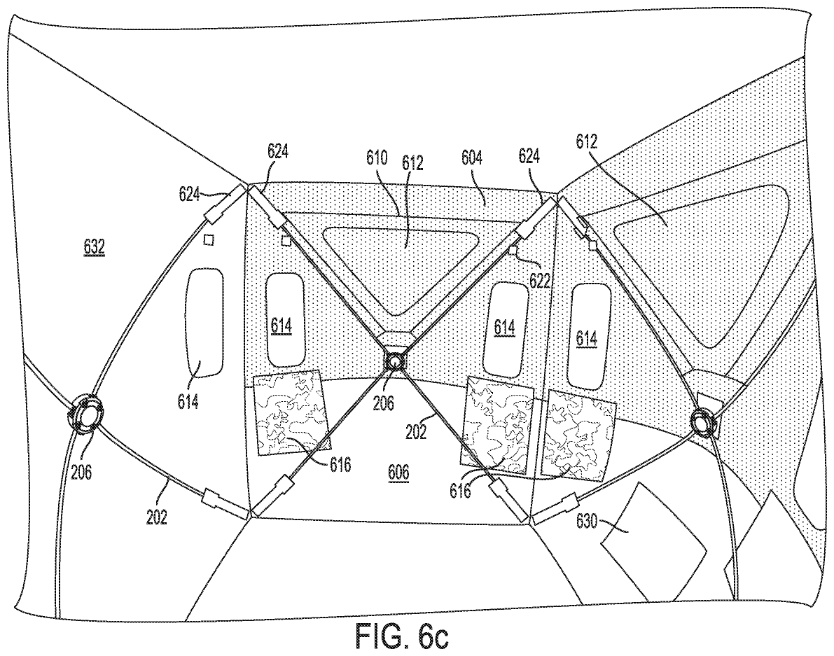

FIGS. 6a-c depict an alternative embodiment of the portable outdoor shelter 600. FIG. 6a depicts a perspective view of the portable outdoor shelter 600 according to an embodiment of the disclosure. FIG. 6b depicts an opposing perspective view of the portable outdoor shelter 600 of FIG. 6a. The portable outdoor shelter 600 in an example embodiment may include one or more sides in which the upper portion 604 of the flexible cover 602 is a one-way transmissive mesh material. The lower portion 606 of the flexible cover 602 may be formed of an opaque material, with the upper and lower portions being dimensioned as described with respect to FIGS. 5a-d. The remaining sides may include an upper portion 604 formed of or including an opaque material like that of the lower portion 606 of the flexible cover 602.

A seam where the upper portion 604 and the lower portion 606 intersect may be covered by a joining strap 608. The flexible cover 602 may include windows 610, 614 for looking out of the portable outdoor shelter 600 without obstruction. Window covers 612, 616 may be disposed over the windows 610, 614 for covering the windows 610, 614 thereby obscuring the inside of the shelter 600 from view. The window covers 612, 616 may be formed from or include either the material of the one-way transmissive mesh or the opaque material of the flexible cover 602. A fastener 618 may connect the flexible cover 602 with an internal frame of the portable outdoor shelter 600. A fastener strap 620 may be connected to the fastener 618 and configured to apply a force to the internal frame of the portable outdoor shelter 600. The fastener strap 620 may be configured to be used as a tie-down for securing the shelter 600 in place.

FIG. 6c illustrates an internal view of the portable outdoor shelter 600. The portable outdoor shelter 600 may include an internal frame including one or more wall supports 200 including frame members 202 and a hub 206, as described herein. The frame members 202 may operatively connect with the flexible cover 602 by strut recesses 624 disposed on an interior of the flexible cover 602. The strut recesses may be sized and shaped to receive the strut caps and frame members 202 in a friction engagement. A pouch 630 may be disposed on the interior of the flexible cover 602. The windows 610, 614 may be covered by window covers 612, 616 by fastening the window covers 612 and 616 to a cover fastener 622. The window covers 616 may be affixed along a side opposite the window 614 from the cover fasteners 622. The window cover 612 may be affixed directly to the frame members 202 using hooks, clasps or the like (not shown) to close the window. Additionally, the shelter may feature at least one wall 632 that may be formed entirely of one material, such as the one-way transmissive mesh or the opaque, light absorbing material. The shelter may include a movable/removable back drop panel (e.g. 548 as shown in FIG. 5d).

Although a roof panel 110 may be formed from opaque material of the flexible cover 102, it should be appreciated that in an alternative embodiment the roof panel may, in whole or in part, be formed of mesh material, for example if a moveable back drop or black-out panel is used to enhance the transmissivity of the mesh material in the roof panel.

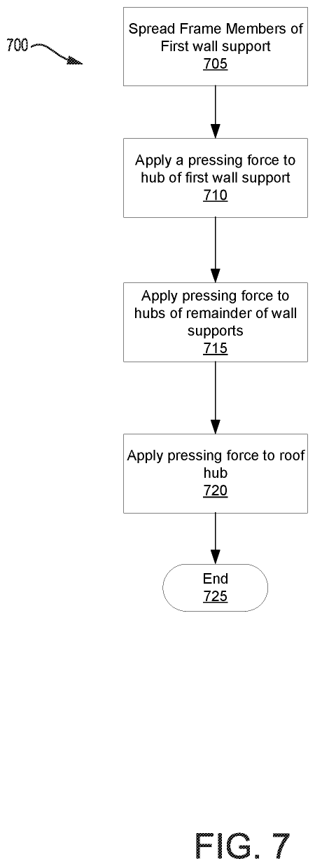

According to an aspect of the present disclosure a method for erecting a structure is presented. FIG. 7 depicts an exemplary flow chart 700 of one such method. As shown in block 705, the substantially rigid frame members of a first independent wall support as described herein may be spread from a collapsed position. Each of the substantially rigid frame members may have a distal end and a proximal end. The proximal end may be engaged in an aperture of a hub while the distal end may be engaged with at least one fixture point of a flexible cover. Each of the substantially rigid frame members may have a length greater than a distance from the hub center point to the fixture point.

Further according to the exemplary method, as shown in block 710 a pressing force may be applied on the hub of the first independent wall support against the flexible cover. This may be done while maintaining the hubs of the remaining independent wall supports in proximity to each other. The substantially rigid frame members of the first independent wall support may engage the hub to form a first concave wall in the flexible cover. As shown in block 715, a subsequent pressing force may be applied to each of the hubs of the remaining independent wall supports such that the substantially rigid frame members of each independent wall support engage each respective hub to form a plurality additional concave walls. As shown in block 720, a pressing force may be applied to a roof hub to engage roof support members into an expanded position. As shown in block 725, the process of erecting the structure may completed, establishing a four-walled enclosure with a roof. Each wall and the roof may be independently expandable. To collapse the structure, the steps of the method 700 described herein may be followed in reverse.

While particular dimensions and ratios of upper portion transmissive material to lower portion non-transmissive materials are described in relation to the form of a side wall of the shelter disclosed herein, it should be appreciated that dimensions and ratios other than described may fall within the scope of the present disclosure.

Further, although wall supports are described and illustrated herein as comprising four frame members configured at one end into a hub, one skilled in the art should appreciate that more or less than four frame members may be implemented according to the disclosure, and not all frame members in a structure must be configured into a hub as described in supporting the shelter.

The detailed description of aspects of the present disclosure set forth herein refers to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” “substantially,” or the like, when accompanying a numerical value or direction are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the foregoing description or claims, it is understood that terms such as “first,” “second,” “third,” “top,” “bottom,” “side,” “above,” “below,” and the like, are words of convenience and are not to be construed as limiting terms unless expressly stated otherwise. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used herein, specify the presence of stated features, steps, operations, elements, and/or components, but do not preclude the presence or addition of one or more other features, steps, operations, elements, components, and/or groups thereof.

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A collapsible structure comprising:
a flexible cover defining at least one wall and a roof, the at least one wall including at least a one-way transmissive, mesh portion and one fixture point;
at least one wall support collapsibly engaged with at least one wall of the flexible cover, the at least one wall support comprising:
a hub having a center point and defining at least one aperture;
at least one substantially rigid frame member having a distal end and a proximal end, the proximal end retained in the at least one aperture, the distal end engaged with the at least one fixture point of the flexible cover, the substantially rigid frame member having a length greater than a distance from the hub center point to the fixture point;
wherein the at least one substantially rigid frame member is configured to pivot between an engaged position and a collapsed position with the at least one hub, the engaged position forming a tension in the at least one wall about the at least one wall support.

2. The collapsible shelter of claim 1 wherein the flexible cover comprises an upper portion and a lower portion, the upper portion comprising the one-way transmissive mesh material.

3. The collapsible shelter of claim 2 wherein the one-way transmissive mesh portion provides a 360° view through the upper portion of the flexible cover.

4. The collapsible shelter of claim 2 further comprising a removable light-absorbing panel securable to an interior of the flexible cover.

5. The collapsible shelter of claim 2 wherein the one-way transmissive mesh portion provides a 270° view through the upper portion of the flexible cover.

6. The collapsible shelter of claim 2 wherein the one-way transmissive mesh portion provides a 180° view through the upper portion of the flexible cover.

7. The collapsible shelter of claim 2 wherein the lower portion comprises an opaque light-absorbing material.

8. The collapsible shelter of claim 1 wherein the at least one wall support comprises four collapsible wall supports, each collapsible wall support independently engaged with the flexible cover.

9. The collapsible shelter of claim 1 wherein:
the at least one substantially rigid frame member comprises four substantially rigid frame members and;
the at least one fixture point comprises four fixture points, each fixture point disposed near an edge of the at least one wall, each of the four substantially rigid frame members engaging each of the four fixture points.

10. The collapsible shelter of claim 9 wherein the four fixture points are disposed near the corners of the at least one wall of the flexible cover.

11. The collapsible shelter of claim 1 wherein the flexible cover comprises a camouflage outer surface.

12. The collapsible shelter of claim 1 further comprising a roof support including a roof hub and at least one roof support member, the roof support member engaged with the roof of the flexible cover.

13. The collapsible shelter of claim 1 wherein the flexible cover defines at least one window.

14. The collapsible shelter of claim 13 wherein the at least one window comprises a corner window defined between an upper portion and lower portion of the flexible cover, the corner window spanning at least two walls of the flexible cover.

15. The collapsible shelter of claim 13 further comprising a window cover securable over the at least one window, the window cover affixed to the flexible cover along one side of the window cover.

16. The collapsible shelter of claim 1 further comprising a window fastener opposite the window from the affixed side of the window cover.

17. The collapsible shelter of claim 1 wherein:
the hub defines a notch;
the substantially rigid frame member comprises a protrusion extending from the proximal end, the protrusion engaging the notch of the hub in the engaged position.

18. The collapsible shelter of claim 1 wherein the flexible cover further defines a door.

19. A collapsible shelter comprising:
a flexible cover defining four walls and a roof, each wall comprising four fixture points, the flexible cover comprising a first portion and a second portion, the first portion including a one-way transmissive material, the second portion including an opaque, light-absorbing material;
four independently collapsible wall supports, each wall support engaged with each wall of the flexible cover, each wall support comprising:
a hub having a center point and defining four apertures;
four substantially rigid frame members, each having a distal end and a proximal end, each proximal end retained in each aperture, the distal end engaged with the at least one fixture point of the flexible cover, each substantially rigid frame member having a length greater than a distance from the hub center point to the fixture point;
wherein the at least one substantially rigid frame member is configured to pivot between an engaged position and a collapsed position with the at least one hub, the engaged position forming a tension in the at least one wall about the at least one wall support; and
a roof hub and four roof support members, the roof support members engaging the roof of the flexible cover.

20. A method of erecting a structure, the method comprising:
spreading a plurality of substantially rigid frame members of a first of a plurality of independent wall supports from a collapsed position, each of the plurality of substantially rigid frame members having a distal end and a proximal end, the proximal end engaged in an aperture of a hub, the distal end engaged with at least one fixture point of a flexible cover, each substantially rigid frame member having a length greater than a distance from the hub center point to the fixture point;
applying a pressing force on the hub of the first independent wall support against the flexible cover maintaining the hubs of a remainder of the plurality of independent wall supports in proximity to each other and such that the plurality of substantially rigid frame members engage the hub to form a first concave wall in the flexible cover;
applying a subsequent pressing force to each of the hubs of the remainder of the plurality of independent wall supports such that the respective substantially rigid frame members of each independent wall support engage each hub to form a plurality additional concave walls; and
applying a pressing force to a roof hub to engage a plurality of roof support members into an expanded position.
